(19) United States
(12) Patent Application Publication
(10) Pub. No.: US 2020/0003246 A1
(43) Pub. Date: Jan. 2, 2020

(54) Pressure System

(71) Applicant: Haskel Europe Ltd., Sunderland (GB)

(72) Inventors: Peter W. Kaveney, South Shields (GB); Paul Harrison, Washington (GB)

(73) Assignee: Haskel Europe Ltd., Sunderland (GB)

(21) Appl. No.: 16/322,860

(22) PCT Filed: Aug. 17, 2017
(86) PCT No.: PCT/IB2017/001127

§ 371 Date: Feb. 1, 2019

(30) Foreign Application Priority Data
Aug. 19, 2016 (GB) 1614238.2
Aug. 26, 2016 (GB) 1614587.2

(51) Int. Cl. F16B 31/04; B23P 19/06; B25B 29/02

(52) U.S. Cl. CPC F16B 31/043; B25B 29/02; B23P 19/067

(57) ABSTRACT

A pressurising system for bolt tensioning, comprising: an inlet for receiving compressed gas; a fluid outlet for connection to a bolt tensioning device; a pump for pumping fluid for increasing the pressure at the fluid outlet, the pump being coupled to the inlet for being driven by compressed gas received at the inlet; a negative pressure generator coupled to the outlet for decreasing the pressure at the fluid outlet, the negative pressure generator being coupled to the inlet for being driven by compressed gas received at the inlet.

### BACKGROUND

This invention relates to a pressuring system for assisting the retraction of a hydraulic bolt tensioner.

When parts are bolted together it is generally desirable to apply a preload to the bolt so that the bolt is kept under tension. This reduces the chance of the bolt loosening and can also reduce the incidence of fatigue in the bolt.

When a bolt is being used to hold two parts together it is normally inserted through holes in the two parts, and then a nut is tightened on to the threaded stem of the bolt so as to pinch the parts between the nut and the head of the bolt. The nut bears against an outward-facing face of one of the parts and the head of the bolt bears against the outward-facing face of the other of the parts. To apply a required preload to the bolt the nut may be tightened to a corresponding torque. Alternatively, the bolt may be placed under a specific amount of tension; and then the nut may be tightened so as to close the gap between the nut and the adjacent outward-facing face.

One way to preload a bolt is to tighten it, or a nut threaded on to it, to a predetermined torque. This approach has a number of problems. To achieve high preloads very large tools are needed. It is difficult to achieve a precise preload because the applied torque is influenced by friction as the nut or bolt is tightened. It can be difficult to tighten multiple bolts on a single joint simultaneously, which can lead to offsets.

To address these problems, hydraulic bolt tensioners are used to apply tension to bolts so as to assist in tightening fasteners such as nuts on to the bolts. Hydraulic bolt tensioners act on a bolt whose stem is extending out of a part against which the bolt is to be tightened. A nut is threaded on to the exposed bolt stem. The hydraulic bolt tensioner has two elements. An operator attaches the first element to the bolt stem distally of the nut. The second element acts against the face of the component from which the bolt stem is extending. When hydraulic pressure is applied to the bolt tensioner a hydraulic actuator comprised in the bolt tensioner forces the two elements apart. This applies tension to the bolt. Once the bolt has been stretched to the desired tension, any air gap between the nut and the face of the component is closed by turning the nut. This locks the preload into the bolt. An example of a hydraulic bolt tensioner is disclosed at https://www.youtube.com/watch?v=BGdcHPf6IK4.

After a bolt tensioning operation has been completed, a need arises to remove the bolt tensioner from the bolt so it can be used for the next tensioning operation. The hydraulic pressure is released from the actuator of the bolt tensioner. Because the bolt tensioner has been applying a high level of force, it can happen that even when the hydraulic pressure is released the bolt tensioner remains jammed against the face of the component it is acting on. This makes it difficult to remove the bolt tensioner. An operator might have to manually use a hand tool such as a pry bar to lever the elements of the bolt tensioner together so as to free it from the component. This is arduous work and can lead to injuries such as repetitive strain injury.

It would be desirable to make it easier to remove a hydraulic bolt tensioning device from a bolt, for example by reducing the force needed to manually retract the hydraulic bolt tensioning device.

### SUMMARY OF THE INVENTION

According to a first aspect of the invention, there is provided a pressurising system for bolt tensioning, comprising: an inlet for receiving compressed gas; a fluid outlet for connection to a bolt tensioning device; a pump for pumping fluid for increasing the pressure at the fluid outlet, the pump being coupled to the inlet for being driven by compressed gas received at the inlet; a negative pressure generator coupled to the outlet for decreasing the pressure at the fluid outlet, the negative pressure generator being coupled to the inlet for being driven by compressed gas received at the inlet.

The negative pressure generator may be configured for urging the interior of a fluid reservoir towards a negative pressure (e.g. a pressure below atmospheric pressure) in response to being driven by compressed gas received at the inlet.

According to a second aspect of the invention, there is provided a pressurising system for bolt tensioning, comprising: an inlet for receiving compressed gas; a fluid outlet for connection to a bolt tensioning device; a fluid reservoir having a headspace; a pump for pumping fluid from the reservoir for increasing the pressure at the fluid outlet, the pump being coupled to the inlet for being driven by compressed gas received at the inlet; a negative pressure generator communicating with the headspace of the reservoir for decreasing the pressure at the fluid outlet by decreasing the pressure in the reservoir.

The negative pressure generator may be configured for reducing the pressure in the reservoir and/or at the fluid outlet to below atmospheric pressure.

The pressurising system may comprise a valve arranged to selectively couple the inlet to the pump or the negative pressure generator.

The negative pressure generator may be a Venturi tube arranged to receive gas flow from the inlet along a primary passage having a constriction therein, and thereby generating a negative pressure in a secondary passage, the secondary passage being coupled so as to act on the fluid outlet.

The pressurising system may comprise a fluid reservoir coupled to the pump for supplying the fluid to the pump, wherein the negative pressure generator communicates with the reservoir for applying a negative pressure to the reservoir.

The negative pressure generator may communicate with an upper region of the reservoir.

The negative pressure generator may communicate with headspace of the reservoir.

The secondary passage of the Venturi tube may communicate with the upper region of the reservoir whereby the Venturi tube can serve as a breather for the reservoir.

The pressurising system may also comprise: a first fluid route between the reservoir and the outlet, the pump being located in the first fluid route; and a second fluid route between the reservoir and the outlet for conveying negative pressure to the outlet.

The pressurising system may comprise a manually adjustable pressure regulator acting between the inlet and the pump, whereby the pressure of the compressed gas to the pump can be adjusted.

The pressurising system may comprise a preset pressure regulator acting between the inlet and the negative pressure generator, whereby the pressure of the compressed gas to the negative pressure generator can be fixed.

The bolt tensioning system may also comprise: a hydraulic bolt tensioner having an inlet for receiving fluid to apply tension to a bolt; and a pressurising system as described above, the fluid outlet of the pressurising system being coupled to the inlet of the hydraulic bolt tensioner.

The bolt tensioning system may comprise: a cap having a female thread for connection to a bolt stem; a shoe; and a hydraulic actuator counted between the cap and the shoe for urging the shoe to move axially of the thread for applying tension to a bolt engaged with the thread, the inlet of the hydraulic bolt tensioner being coupled to the hydraulic actuator for causing the actuator to apply tension to the bolt.

According to a third aspect of the invention, there is provided a method for bolt tensioning, comprising: receiving compressed gas through an inlet; connecting a bolt tensioning device to a fluid outlet of a pressure generator; pumping fluid using a pump to increase the pressure at the fluid outlet, the pump being coupled to the inlet for being driven by compressed gas received at the inlet; coupling a negative pressure generator to the outlet for decreasing the pressure at the fluid outlet, the negative pressure generator being coupled to the inlet for being driven by compressed gas received at the inlet.

The inlet may be a pipe coupling. The outlet may be a pipe coupling.

According to a fourth aspect of the invention, there is provided a method for tensioning a bolt, the method comprising: applying hydraulic pressure to a hydraulic bolt tensioner, the hydraulic pressure being applied by conveying fluid from a fluid reservoir to the hydraulic bolt tensioner; and relieving the action of the hydraulic bolt tensioner by reducing the hydraulic pressure; wherein the step of relieving the action of the hydraulic bolt tensioner comprises applying a negative gas pressure to a headspace of the fluid reservoir.

The method may optionally comprise applying a nut to the stem of the bolt.

The bolt may be extending through a face.

The step of increasing the pressure at the fluid outlet or applying pressure to the hydraulic bolt tensioner may cause the bolt to be tensioned, e.g. by the hydraulic bolt tensioner acting against a face through which the bolt extends.

The method may optionally comprise attaching a hydraulic bolt tensioner to the bolt.

The method may optionally comprise receiving compressed gas through an inlet of a pressure generator.

The method may optionally comprise connecting a bolt tensioning device to a fluid outlet of the pressure generator.

The method may optionally comprise pumping fluid using a pump to increase the pressure at the fluid outlet, the pump being coupled to the inlet for being driven by compressed gas received at the inlet, thereby tensioning the bolt by applying hydraulic pressure to the hydraulic bolt tensioner so as to cause it to act against the face, the hydraulic pressure being applied by conveying fluid from a fluid reservoir to the hydraulic bolt tensioner.

The method may optionally comprise advancing the nut along the stem of the bolt;

The method may optionally comprise relieving the action of the hydraulic bolt tensioner against the face by reducing the hydraulic pressure.

The method may optionally comprise removing the hydraulic bolt tensioner from the bolt.

The step of relieving the action of the hydraulic bolt tensioner may optionally comprise coupling a negative pressure generator to the outlet for decreasing the pressure at the fluid outlet, the negative pressure generator being coupled to the inlet for being driven by compressed gas received at the inlet.

### BRIEF DESCRIPTION OF THE FIGURE

The present invention will now be described by way of example with reference to the accompanying drawing.

FIG. 1 shows a diagram of a pressuring system for bolt tensioning.

### DETAILED DESCRIPTION

The description below concerns a pressurising system for bolt tensioning. The system supplies hydraulic pressure to a bolt tensioning device by pumping hydraulic fluid from a fluid reservoir. After the tensioning operation has been completed, hydraulic fluid is urged out of the device by applying a negative pressure to the fluid reservoir. Thus the hydrostatic pressure applied to the bolt tensioning device is reduced, allowing easier removal of the device by an operator.

The system described below may be used to tension a bolt extending through a face. After tension has been applied a nut threadedly engaged with the stem of the bolt can be advanced onto the bolt so as to tighten the bolt in place.

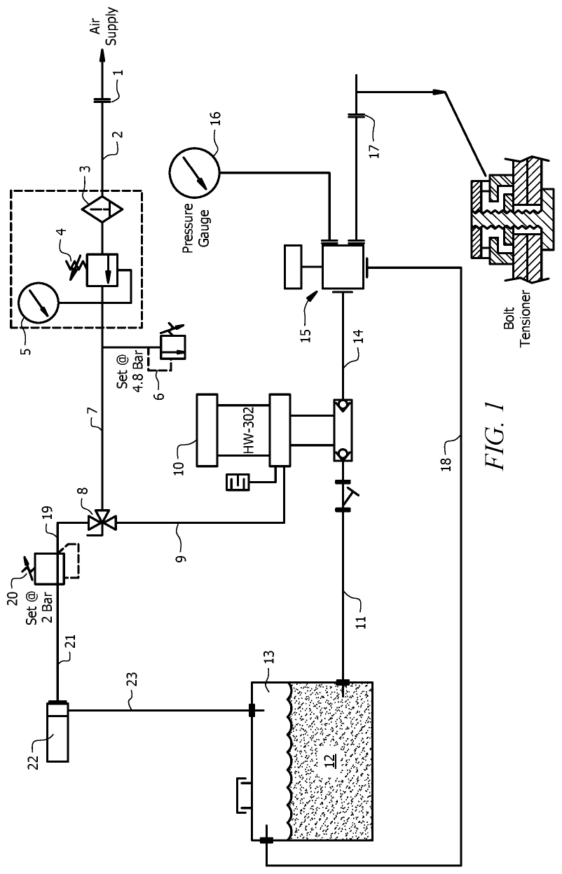

FIG. 1 shows a system for pressurising a hydraulic bolt tensioning device.

The pressurising system of FIG. 1 may be coupled to a hydraulic bolt tensioning device via a fluid outlet 17. The hydraulic bolt tensioning device may be of any suitable commercially available type. Typically, the bolt tensioner will comprise a first element, a second element and a hydraulic actuator. The first element is configured for connection to the stem of a bolt. The first element may have a female thread for mating to the bolt stem. The hydraulic actuator acts between the first and second elements to force them apart when hydraulic pressure is applied to it. The second element is configured to bear against a face through which the bolt stem is extending so as to, under the action of the hydraulic actuator, apply force against the face in a direction axially with respect to the bolt stem, thereby tensioning the bolt.

A compressed gas supply (e.g. a compressor, pump or accumulator) is attached to the system of FIG. 1 via an inlet 1. The inlet could be terminated by a standard hose connector. The supply feeds gas through pipe 2 to a filter 3. The output of the filter passes to a manually adjustable pressure regulator 4. At 6, a pressure relief valve can vent overpressure to the atmosphere. The blow-off pressure may be set at approximately 4.8 bar.

A valve 8 allows gas from the inlet to be directed to a selected one of a pump 10 (via line 9) and a negative pressure generator 22 (via line 19). Valve 8 may be a three-way valve. Valve 8 may be a ball valve. Valve 8 is arranged to selectively couple the compressed gas inlet to the pump 10 or negative pressure generator 22.

Pump 10 is a gas-driven hydraulic pump. The pump is capable of pressurising a bolt tensioning device connected to outlet 17. The pump may, for example be capable of developing a hydraulic pressure in the range from 500 to 2000 Bar. The pump may be a proportional pneumatic/hydraulic pump which generates a hydraulic pressure of a value proportional to the applied pneumatic pressure. Pump 10 may be an air driven pump. Pump 10 may be operated by pneumatic pressure. The pump may be of the type known as a pneumatic intensifier. Pump 10 may have a nominal pressure ratio of 1:300. With such a pump, at steady state the pressure of the fluid in tube 14 is dependent on the input to the pump: for example, the increase in hydraulic pressure may be proportional to the pneumatic pressure applied to pump via line 9. The pneumatic inlet of the pump is received via line 9. The pump vents consumed gas to the atmosphere. The pump may vent consumed gas to atmosphere by means of a pipe or tube to a vent header located remotely from the work site.

The hydraulic inlet of pump 10 is connected via pipe 11 to a fluid reservoir 12. Fluid reservoir 12 contains fluid which can be supplied to the pump 10. The fluid is a liquid. The fluid may be hydraulic oil. The reservoir has a headspace 13 above the fluid level, such that the remainder of the reservoir not occupied by the fluid is filled with gas, e.g. air. Fluid reservoir 12 is preferably sealed except for its connections to tubes 11, 18 and 23, and for any filler cap. In this way, the fluid reservoir is preferably capable of withstanding a negative pressure of, for example, 0.5 or 0.8 Bar below atmospheric pressure without significantly deforming.

Tube 18 connects fluid reservoir 12 to manifold valve 15 and facilitates the return of fluid to the reservoir after the bolt tensioning operation is complete. At its connection to the reservoir 12 the tube 18 is located at the upper part of the reservoir. The tube 18 opens onto the headspace of the reservoir.

The hydraulic outlet of the pump 10 passes via tube 14 to outlet 17, via manifold valve 15. In one configuration the manifold valve can couple the pump output line 15 to the output 17. In a second configuration the manifold couples the bypass line 18 to the output 17. The pressure of the fluid at the fluid outlet 17 and in tube 14 is indicated by pressure gauge 16.

Tube 19 couples an outlet of valve 8 to a negative pressure generator 22. Tube 19 is connected to a pressure regulator 20. Downstream of pressure regulator 20, tube 21 is connected to negative pressure generator 22. The negative pressure generator 22 is coupled to the headspace of the fluid reservoir 13 by line 23. Line 23 preferably enters the fluid reservoir at the top of the reservoir, and most preferably at its highest point, so the line can reliably open onto the headspace of the reservoir. Line 23 permits the negative pressure generator to apply a negative pressure to the headspace of the reservoir via pneumatic communication with the reservoir. To achieve this, the line may communicate directly (by opening onto the headspace) or indirectly (by opening onto the reservoir below this level) with the headspace of the reservoir.

The negative pressure generator is configured to develop a negative pressure in line 23 under the action of gas flow from the air supply at 1 when the valve 8 is in the appropriate position. In this example the negative pressure generator is a Venturi device. Gas flow from the air supply 1 passes through a constriction in the Venturi device. Line 23 opens into the Venturi device at the constriction. This allows a negative pressure to be developed in line 23.

To perform a bolt tensioning operation, first a bolt is passed through two parts that are to be jointed together. If the bolt is a headed bolt it passes fully though both parts with its head exposed on the outer face of a first one of the parts. If the bolt is a stud bolt it is threadedly engaged with the first one of the parts. In both cases the bolt passes freely though the second one of the parts and extends out of the outer face of that part. A nut is applied to the exposed shaft of the bolt. The bolt tensioner is attached to the bolt shaft distally of the nut. Then the pressurising system is operated to cause tensioning to take place. Valve 8 is configured such that the compressed gas from the inlet 1 that flows along tubes 2 and 7 is directed to the pump 10. The compressed gas may be compressed air, nitrogen or any other suitable gas. The operation of the pump results in fluid being pumped from the reservoir along tube 11, through the pump 10 and into tube 14, where it is then fed to outlet 17 and into the bolt tensioning device. As fluid is passed to the bolt tensioner, air flows in from the atmosphere through the Venturi device 22 and along line 23 to the headspace 13 of the fluid reservoir. In this way the Venturi device acts as a breather for the fluid reservoir. Using the same device as both a breather and a negative pressure generator is especially efficient.

The pressure at outlet 17 may be selected so as to apply a given hydrostatic pressure to the bolt tensioner via fluid outlet 17. In this way the fluid from the reservoir is used to apply a hydrostatic pressure to the bolt tensioning device. The outlet pressure may be set using regulator 4.

Once a bolt tensioning operation has been completed, it may be necessary to remove the tensioning device from the bolt. To facilitate removal of the bolt tensioning device by an operator the following steps are taken. The steps may be taken in either order.

1. Manifold valve 15 is operated to couple bypass line 18 to the output 17. This brings the pressure at the output 17 to the pressure in the fluid reservoir 12. If the negative pressure generator 22 is not presently in operation to generate negative pressure then the pressure in the fluid reservoir is ambient atmospheric pressure since the fluid reservoir is vented to the atmosphere through the tube 23.

2. Three-way valve 8 is operated such that the compressed gas from inlet 1 is directed along tube 19 rather than tube 9. Where valve 8 is a three-way ball valve, this may be done by rotating the ball of the valve. The ball of the valve may be rotated by 90 degrees. The gas then passes through pressure regulator 20 and continues along tube 21 to the negative pressure generator 22. The pressure regulator 20 can fix the pressure of the compressed gas to the negative pressure generator. The pressure of the compressed gas to the negative pressure generator may be fixed at 2 bar. When the negative pressure generator is in operation it reduces the pressure in the fluid reservoir to a negative pressure below ambient atmospheric pressure.

When both of these steps have been taken the outlet 17 is drawn towards a negative pressure by virtue of the action of the negative pressure generator 22. This tends to reduce the pressure acting within the bolt tensioner and thereby retract, or at least loosen, the bolt tensioner, making it easier for an operator to retract it and remove it from the bolt.

In the present example, during step 2 the Venturi tube receives gas flow from the inlet 1 via tubes 2, 7, 19 and 21 when valve 8 is adjusted accordingly. Within the Venturi tube is a constriction, whereby the diameter of the Venturi tube is decreased. The reduction in diameter and hence cross sectional area of the device causes an increase in speed of the gas as it flows through the constriction. This creates a negative pressure which causes a negative pressure or vacuum to be created in the headspace 13 of the fluid reservoir 12. The headspace is coupled to the tap of the Venturi tube by line 23. When a negative pressure is applied, air is sucked from headspace 13 into tube 23. The system may be configured so that when the Venturi tube is in operation to generate negative pressure the pressure in the headspace of the tank is 0.75 Bar absolute pressure. Greater negative pressures can be generated if the reservoir is designed to withstand the higher negative pressure.

As a result of the negative pressure in the headspace of the tank, fluid is urged back from the bolt tensioning device towards the reservoir 12 along tube 18, thus reducing the hydraulic pressure applied to the bolt by the bolt tensioning device. This helps an operator to remove the bolt tensioning device from the bolt. It has been found that retracting the device in this way can result in approximately 30% less force needed by the operator to remove the device. This can help to alleviate injuries such as repetitive strain injuries. It can also speed up the retraction of the bolt tensioning device, resulting in operational time savings.

The fluid reservoir should be resistant to deformation under the negative pressure. In that way the negative pressure formed by generator 22 can be applied to the bolt tensioner.

The pump 10 and the negative pressure device 22 could be driven by separate gas sources. The pump 10 could alternatively be driven by another source. For example, it could be an electric pump.

The negative pressure could be applied to the outlet in other ways. For example, line 23 could couple to a piston and cylinder that can draw a reduced pressure in line 18. A non-return valve could prevent that reduced pressure being applied to the reservoir.

When valve 8 does not allow compressed gas to flow to the Venturi tube, the Venturi tube can serve as a breather for the reservoir. The Venturi tube may allow the reservoir to breathe by allowing the amount of air in the headspace to adjust as the fluid level is depleted when the fluid is supplied to the bolt tensioning device.

The reservoir could breathe through a device other than the Venturi tube.

The vacuum on the fluid reservoir could be provided by a separate pump to pump 10, or by a pneumatic actuator acting on the tank headspace or directly on line 18.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A pressurising system for bolt tensioning, comprising:
an inlet for receiving compressed gas;
a fluid outlet for connection to a bolt tensioning device;
a pump for pumping fluid for increasing the pressure at the fluid outlet, the pump being coupled to the inlet for being driven by compressed gas received at the inlet;
a negative pressure generator coupled to the outlet for decreasing the pressure at the fluid outlet, the negative pressure generator being coupled to the inlet for being driven by compressed gas received at the inlet.

2. A pressurising system as claimed in claim 1, comprising a valve arranged to selectively couple the inlet to the pump or the negative pressure generator.

3. A pressurising system as claimed in claim 1, wherein the negative pressure generator is a Venturi tube arranged to receive gas flow from the inlet along a primary passage having a constriction therein, and thereby generate a negative pressure in a secondary passage, the secondary passage being coupled so as to act on the fluid outlet.

4. A pressurising system as claimed in claim 1 comprising a fluid reservoir coupled to the pump for supplying the fluid to the pump, and wherein the negative pressure generator communications with the reservoir for applying a negative pressure to the reservoir.

5. A pressurising system as claimed in claim 4, wherein the negative pressure generator communicates with an upper region of the reservoir.

6. A pressurising system as claimed in claim 4, wherein the negative pressure generator communicates with headspace of the reservoir.

7. A pressurising system as claimed in claim 4, wherein the secondary passage of the Venturi tube communicates with the upper region of the reservoir whereby the Venturi tube can serve as a breather for the reservoir.

8. A pressurising system as claimed in claim 4, comprising:
a first fluid route between the reservoir and the outlet, the pump being located in the first fluid route; and
a second fluid route between the reservoir and the outlet for conveying negative pressure to the outlet.

9. A pressurising system as claimed in claim 1, comprising a manually adjustable pressure regulator acting between the inlet and the pump, whereby the pressure of the compressed gas to the pump can be adjusted.

10. A pressurising system as claimed in claim 1, comprising a preset pressure regulator acting between the inlet and the negative pressure generator, whereby the pressure of the compressed gas to the negative pressure generator can be fixed.

11. A pressurising system for bolt tensioning, comprising:
an inlet for receiving compressed gas;
a fluid outlet for connection to a bolt tensioning device;
a fluid reservoir having a headspace;
a pump for pumping fluid from the reservoir for increasing the pressure at the fluid outlet, the pump being coupled to the inlet for being driven by compressed gas received at the inlet;
a negative pressure generator communicating with the headspace of the reservoir for decreasing the pressure at the fluid outlet by decreasing the pressure in the reservoir.

12. A pressurising system as claimed in claim 11, comprising a valve arranged to selectively couple the inlet to the pump or the negative pressure generator.

13. A pressurising system as claimed in claim 11, wherein the negative pressure generator is a Venturi tube arranged to receive gas flow from the inlet along a primary passage having a constriction therein, and thereby generate a negative pressure in a secondary passage, the secondary passage being coupled so as to act on the fluid outlet.

14. A pressurising system as claimed in claim 11, wherein the fluid reservoir is coupled to the pump for supplying the fluid to the pump, and wherein the negative pressure generator communicates with the reservoir for applying a negative pressure to the reservoir.

15. A pressurising system as claimed in claim 14, wherein the negative pressure generator communicates with an upper region of the reservoir.

16. A pressurising system as claimed in claim 14, wherein the secondary passage of the Venturi tube communicates with the upper region of the reservoir whereby the Venturi tube can serve as a breather for the reservoir.

17. A pressurising system as claimed in claim 14, comprising:
a first fluid route between the reservoir and the outlet, the pump being located in the first fluid route; and
a second fluid route between the reservoir and the outlet for conveying negative pressure to the outlet.

18. A pressurising system as claimed in claim 11, comprising a manually adjustable pressure regulator acting between the inlet and the pump, whereby the pressure of the compressed gas to the pump can be adjusted.

19. A pressurising system as claimed in claim 11, comprising a preset pressure regulator acting between the inlet and the negative pressure generator, whereby the pressure of the compressed gas to the negative pressure generator can be fixed.

20. (canceled)

21. (canceled)

22. A method for bolt tensioning, comprising:
applying a nut to the stem of the bolt;
attaching a hydraulic bolt tensioner to the bolt;
receiving compressed gas through an inlet of a pressure generator;
connecting a bolt tensioning device to a fluid outlet of the pressure generator;
pumping fluid using a pump to increase the pressure at the fluid outlet, the pump being coupled to the inlet for being driven by compressed gas received at the inlet, thereby tensioning the bolt by applying hydraulic pressure to the hydraulic bolt tensioner so as to cause it to act against the face, the hydraulic pressure being applied by conveying fluid from a fluid reservoir to the hydraulic bolt tensioner;
advancing the nut along the stem of the bolt;
relieving the action of the hydraulic bolt tensioner against the face by reducing the hydraulic pressure; and
removing the hydraulic bolt tensioner from the bolt;
wherein the step of relieving the action of the hydraulic bolt tensioner comprises coupling a negative pressure generator to the outlet for decreasing the pressure at the fluid outlet, the negative pressure generator being coupled to the inlet for being driven by compressed gas received at the inlet.

23. A method for tensioning a bolt extending through a face, the method comprising:
applying a nut to the stem of the bolt;
attaching a hydraulic bolt tensioner to the bolt;
tensioning the bolt by applying hydraulic pressure to the hydraulic bolt tensioner so as to cause it to act against the face, the hydraulic pressure being applied by conveying fluid from a fluid reservoir to the hydraulic bolt tensioner;
advancing the nut along the stem of the bolt;
relieving the action of the hydraulic bolt tensioner against the face by reducing the hydraulic pressure; and
removing the hydraulic bolt tensioner from the bolt;
wherein the step of relieving the action of the hydraulic bolt tensioner against the face comprises applying a negative gas pressure to a headspace of the fluid reservoir.
